(19) United States
(12) Patent Application Publication
(10) Pub. No.: US 2005/0074075 A1
(43) Pub. Date: Apr. 7, 2005

(54) Feeble signal extracting circuit

(76) Inventor: Hiroshi Miyagi, Niigata (JP)

Correspondence Address: DELLETT AND WALTERS, P. O. BOX 2786, PORTLAND, OR, 97208-2786, US

(21) Appl. No.: 10/482,013

(22) PCT Filed: Jun. 26, 2002
(86) PCT No.: PCT/JP02/06401

(30) Foreign Application Priority Data
Jul. 25, 2001 (JP) 2001-224894
Jul. 26, 2001 (JP) 2001-225860

(51) Int. Cl. H04L 27/06

(52) U.S. Cl. 375/316

(57) ABSTRACT

A feeble signal extracting circuit with a simple structure for extracting a feeble signal such as a pilot signal. A pilot signal extracting circuit 22 comprises a band elimination filter (BEF) 30, an analog subtracter 31, an amplifier 32, and a voltage comparator 33. The band elimination filter 30 removes only the frequency components at and near 19 kHz corresponding to the pilot signal and passes the other frequency components. The analog subtracter 31 receives a stereo composite signal inputted from an FM detection circuit 18 and the signal produced by removing the pilot signal from the stereo composite signal by passing the stereo composite signal through the band elimination filter 30, outputs the differential signal of the two signals, and thus extracts only the pilot signal.

### TECHNICAL FIELD

The present invention relates to a feeble signal extracting circuit for separating and extracting a feeble signal included in an inputted signal, that is, a pilot signal included in a composite signal after FM detection, for instance. The “feeble signal” in this specification refers to a signal of which crest value is smaller than voltage variation of the signal on which this feeble signal is superimposed.

### BACKGROUND ART

An FM receiver has an FM demodulation circuit for reproducing an L signal and an R signal from a stereo composite signal after FM detection. The FM demodulation circuits are divided broadly into those of a matrix method and those of a switching method, and both the methods are common in that they use a pilot signal superimposed on the stereo composite signal to extract the L signal and R signal.

A general communication device performs various demodulation processes after detecting and amplifying a feeble signal included in a receiving signal. For instance, in the case of performing data communication by connecting a phone line and so on to a modem built in the communication device, it is necessary to extract the feeble signal transmitted at a predetermined speed in the communication device. It is necessary likewise to extract the feeble signal in the communication device (receiver) not only in the case of performing the data communication via a wire circuit such as the phone line but also in the case of performing data communication wirelessly or delivering data in a broadcast form rather than one-to-one communication.

As the above-mentioned pilot signal is very feeble and there is voltage variation due to other components, it is difficult to extract the pilot signal merely by comparing it with a predetermined threshold voltage. For this reason, there is a problem that it is necessary to generate a signal synchronized with the feeble pilot signal by using a PLL (Phase-Locked Loop) circuit and so the configuration becomes complicated.

Likewise, in the case of receiving the feeble signal via the above-mentioned wire circuit or wirelessly, it is difficult, if there is the voltage variation of the entire signal level on which the feeble signal is superimposed, to extract the feeble signal merely by comparing it with the predetermined threshold voltage. For this reason, there is a problem that it is necessary to generate the signal synchronized with the feeble signal by using the PLL (Phase-Locked Loop) circuit and so the configuration becomes complicated.

### DISCLOSURE OF THE INVENTION

The present invention was created in view of these points, and an object thereof is to provide a feeble signal extracting circuit having a simple configuration and capable of extracting a feeble signal such as a pilot signal.

To solve the above-mentioned problem, in order to separate and extract the pilot signal superimposed on an FM modulated wave signal, the feeble signal extracting circuit according to the present invention comprises a pilot signal elimination unit for eliminating the pilot signal included in an inputted FM modulated wave signal on which the pilot signal is superimposed, and an analog subtraction unit for outputting a differential of the signal before and after the pilot signal is eliminated by the pilot signal elimination unit. It is possible, by a simple configuration for outputting the differential of the signal before and after eliminating the pilot signal, to eliminate influence of voltage variation other than that of the pilot signal so as to extract only the pilot signal.

It is desirable that the above-mentioned pilot signal elimination unit is a band elimination filter for eliminating only a frequency component corresponding to the pilot signal. If the signal through the band elimination filter is observed, a phase significantly changes in the proximity of a frequency of the pilot signal which is a blocking area. In the case of seeking the differential of the signal before and after passing the filter, however, only the pilot signal included in the signal before passing the filter is outputted so that the pilot signal of which phase is not changed can be extracted. In particular, if an attempt is made to extract only the pilot signal by using a band-pass filter, the phase significantly changes in a passing area of this filter, that is, in the proximity of the frequency of the pilot signal to be passed, and so the configuration for adjusting the phase is required. However, the feeble signal extracting circuit according to the present invention does not require the configuration for making such an adjustment so that the configuration can be simplified.

It is desirable that it further comprises an amplifier for amplifying an output signal of the above-mentioned analog subtraction unit and a voltage comparator for comparing a voltage of the signal amplified by the amplifier with a predetermined threshold voltage. As it can thereby eliminate the influence of the voltage variation other than that of the pilot signal and extract the pilot signal of which phase is not changed, it is possible to generate a pulse signal synchronized with the pilot signal by a simple configuration to which the amplifier and the voltage comparator are further added.

The feeble signal extracting circuit of the present invention comprises a feeble signal elimination unit for eliminating the feeble signal included in an inputted signal on which the feeble signal having a predetermined frequency is superimposed, and the analog subtraction unit for outputting the differential of the signal before and after the feeble signal is eliminated by the feeble signal elimination unit. It is possible, by a simple configuration for outputting the differential of the signal before and after eliminating the feeble signal, to eliminate the influence of voltage variation other than that of the feeble signal so as to extract only the feeble signal.

It is desirable that the above-mentioned feeble signal elimination unit is the band elimination filter for eliminating only the frequency component corresponding to the feeble signal. If the signal through the band elimination filter is observed, the phase significantly changes in the proximity of the frequency of the feeble signal which is the blocking area. In the case of seeking the differential of the signal before and after passing the filter, however, only the feeble signal included in the signal before passing the filter is outputted so that the feeble signal of which phase is not changed can be extracted.

It is desirable that the above-mentioned feeble signal is the signal of which crest value is smaller than the voltage variation of the signal on which this feeble signal is superimposed. In particular, such a feeble signal is completely hidden in the voltage variation of the entire signal including the feeble signal, and so it cannot be detected by a simple voltage comparison. It is possible, however, to securely extract only the feeble signal by using the feeble signal extracting circuit of the present invention.

It is desirable that it further comprises the amplifier for amplifying the output signal of the above-mentioned analog subtraction unit and the voltage comparator for comparing the voltage of the signal amplified by the amplifier with the predetermined threshold voltage. As it can thereby eliminate the influence of the voltage variation other than that of the feeble signal and extract the feeble signal of which phase is not changed, it is possible to generate a pulse signal synchronized with the feeble signal by the simple configuration to which the amplifier and the voltage comparator are further added.

### Brief description of the Drawings

FIG. 1 is a diagram showing a configuration of an FM receiver including the pilot signal extracting circuit according to this embodiment;

FIG. 2 is a diagram showing a detailed configuration of the stereo demodulation circuit;

FIG. 3 is a diagram showing a detailed configuration of the pilot signal extracting circuit;

FIG. 4 are diagrams showing input-output waveforms of the sections of the pilot signal extracting circuit; and

FIG. 5 is a diagram showing a detailed configuration of a feeble signal extracting circuit for extracting the feeble signal by using the same technique as the above-mentioned pilot signal extracting circuit.

### BEST MODE FOR CARRYING OUT THE INVENTION

Hereafter, a pilot signal extracting circuit according to an embodiment of the present invention will be described in detail.

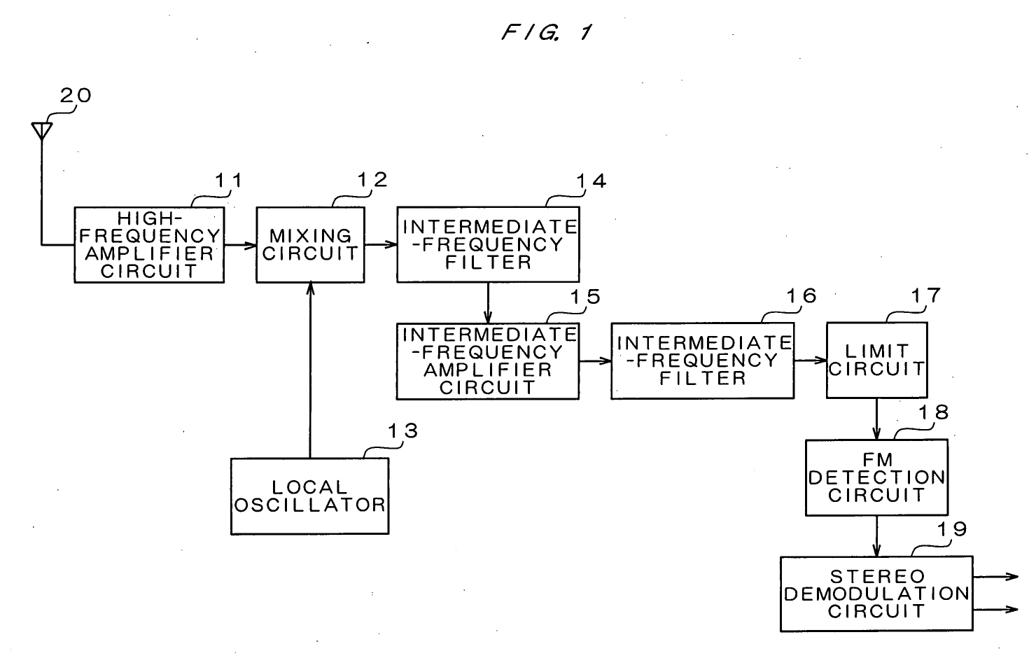

FIG. 1 is a diagram showing a configuration of an FM receiver including the pilot signal extracting circuit according to this embodiment. The FM receiver shown in FIG. 1 is comprised of a high-frequency amplifier circuit 11, a mixing circuit 12, a local oscillator 13, intermediate-frequency filters 14, 16, an intermediate-frequency amplifier circuit 15, a limit circuit 17, an FM detection circuit 18 and a stereo demodulation circuit 19.

After amplifying an FM modulated wave signal received by an antenna 20 with the high-frequency amplifier circuit 11, a high-frequency signal is converted into an intermediate-frequency signal by mixing it with a local oscillation signal outputted from the local oscillator 13. The intermediate-frequency filters 14 and 16 are provided to a preceding stage and a subsequent stage to the intermediate-frequency amplifier circuit 15, and extract only a predetermined band component from an inputted intermediate-frequency signal. The intermediate-frequency amplifier circuit 15 amplifies some intermediate-frequency signals passing through the intermediate-frequency filters 14 and 16.

The limit circuit 17 amplifies the inputted intermediate-frequency signal with a high gain. The FM detection circuit 18 performs FM detection to a signal of fixed amplitude outputted from the limit circuit 17. The stereo demodulation circuit 19 performs stereo demodulation to a stereo composite signal after the FM detection outputted from the FM detection circuit 18 so as to generate an L signal and an R signal.

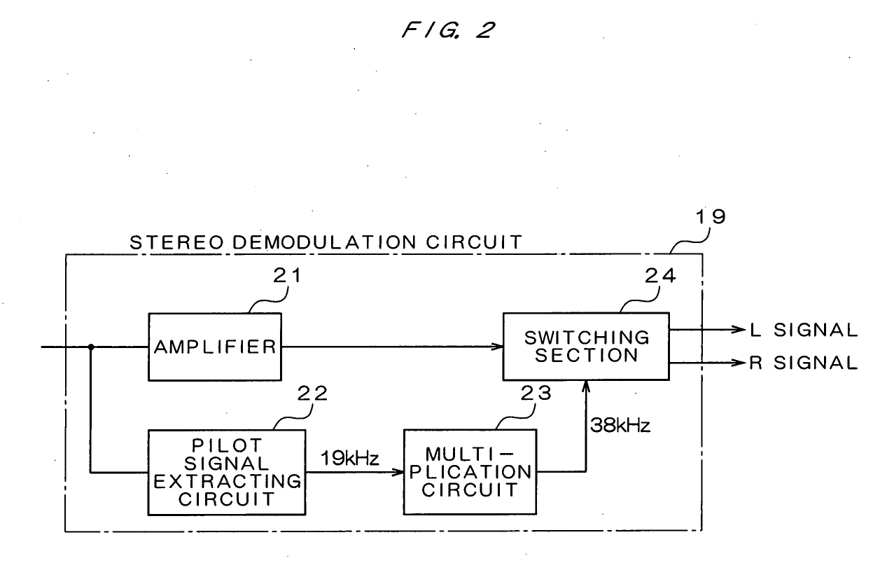

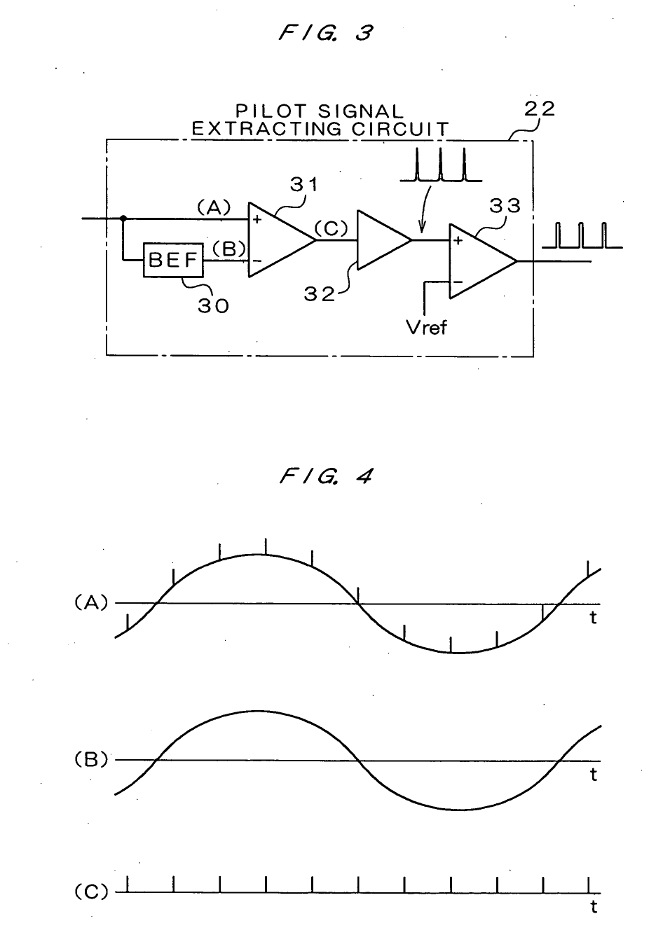

FIG. 2 is a diagram showing a detailed configuration of the stereo demodulation circuit 19, and it shows an overview configuration in the case of adopting a switching method for instance. As shown in FIG. 2, the stereo demodulation circuit 19 is comprised of an amplifier 21, a pilot signal extracting circuit 22, a multiplication circuit 23 and a switching section 24.

The amplifier 21 amplifies the stereo composite signal (composite signal) inputted from the FM detection circuit 18 of the preceding stage. The pilot signal extracting circuit 22 as a feeble signal extracting circuit separates and extracts a pilot signal of 19 kHz superimposed on the stereo composite signal.

The multiplication circuit 23 generates the signal of 38 kHz which synchronizes to the pilot signal and has the frequency of twice. The switching section 24 performs a switching operation synchronized with the signal of 38 kHz outputted from the multiplication circuit 23 to the amplified stereo composite signal inputted from the amplifier 21 so as to separate an L signal and an R signal included in the stereo composite signal.

FIG. 3 is a diagram showing a detailed configuration of the pilot signal extracting circuit 22. As shown in FIG. 3, the pilot signal extracting circuit 22 is comprised of a band elimination filter (BEF) 30, an analog subtracter 31, an amplifier 32 and a voltage comparator 33.

The band elimination filter 30 eliminates only a frequency component in the proximity of 19 kHz corresponding to the pilot signal, and passes other frequency components. The band elimination filter 30 is corresponding to a pilot signal elimination unit.

The analog subtracter 31 has the stereo composite signal inputted from the FM detection circuit 18 and the signal in which the pilot signal is eliminated from the stereo composite signal by passing it through the band elimination filter 30 inputted thereto, and outputs a differential voltage of these two types of signals. The analog subtracter 31 is corresponding to the analog subtraction unit.

The amplifier 32 amplifies an output voltage of the analog subtracter 31. The voltage comparator 33 compares the output voltage of the amplifier 32 with a predetermined threshold voltage Vref, and renders output high-level when the output voltage is the threshold voltage Vref or higher.

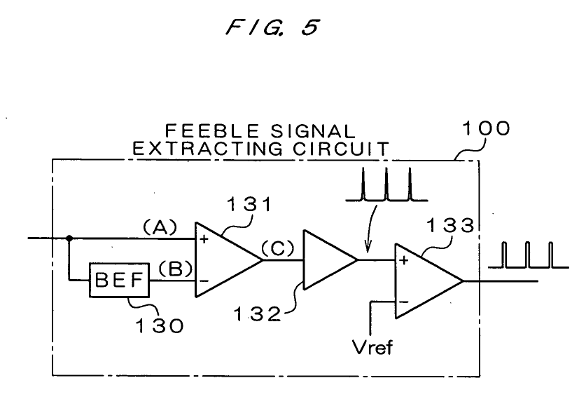

FIG. 4 are diagrams showing input-output waveforms of the sections of the pilot signal extracting circuit 22. FIG. 4(A) shows the waveform of the stereo composite signal inputted to each of the band elimination filter 30 and the analog subtracter 31. FIG. 4(B) shows the waveform of an output signal of the band elimination filter 30. FIG. 4(C) shows the waveform of the output signal of the analog subtracter 31.

Two input terminals of the analog subtracter 31 have the stereo composite signal before eliminating the pilot signal (FIG. 4(A)) and the stereo composite signal after eliminating the pilot signal (FIG. 4(B)) inputted thereto. Therefore, the analog subtracter 31 can output the differential voltage of these two input signals so as to extract only the pilot signal (FIG. 4(C)). The pilot signal thus extracted is not influenced by the voltage variation due to any other frequency component. Therefore, it is possible, by amplifying a voltage level with the amplifier 32 of the subsequent stage and then having it compared with the predetermined threshold voltage Vref by the voltage comparator 33, to easily generate a pulse signal synchronized with the pilot signal.

Thus, as for the pilot signal extracting circuit 22 of this embodiment, it is possible, by using a simple configuration necessary to output the differential voltage of the stereo composite signal before and after eliminating the pilot signal, to get rid of the influence of the voltage variation other than that of the pilot signal so as to extract only the pilot signal. For this reason, it is possible to simplify the configuration compared to the case of using a PLL circuit as in the past.

If the signal through the band elimination filter 30 is observed, a phase significantly changes in the proximity of a frequency of the pilot signal which is a blocking area. In the case of seeking the differential of the signal before and after passing the filter, however, only the pilot signal included in the signal before passing the filter is outputted so that the pilot signal of which phase is not changed can be extracted. In particular, if an attempt is made to extract only the pilot signal by using a band-pass filter, the phase significantly changes in a passing area of this filter, that is, in the proximity of the frequency of the pilot signal to be passed, and so the configuration for adjusting the phase is required. However, the pilot signal extracting circuit according to this embodiment does not require the configuration for making such an adjustment so that the configuration can be further simplified.

It is possible, from the analog subtracter 31, to get rid of the influence of the voltage variation other than that of the pilot signal and output the pilot signal without phase change. Therefore, it is possible to generate the pulse signal synchronized with the pilot signal by the simple configuration to which the amplifier 32 and the voltage comparator 33 are further added.

The above-mentioned embodiment described the pilot signal extracting circuit for extracting the pilot signal included in an FM composite signal. It is possible, however, to extract a feeble signal other than the pilot signal by using the same technique.

FIG. 5 is a diagram showing a detailed configuration of a feeble signal extracting circuit 100 for extracting the feeble signal by using the same technique as the above-mentioned pilot signal extracting circuit 22. The feeble signal extracting circuit 100 shown in FIG. 5 is comprised of a band elimination filter (BEF) 130, an analog subtracter 131, an amplifier 132 and a voltage comparator 133.

The band elimination filter 130 eliminates only the frequency component corresponding to the feeble signal, and passes any other frequency component. The band elimination filter 130 is corresponding to a feeble signal elimination unit.

The analog subtracter 131 has the signal inputted to the feeble signal extracting circuit 100 and the signal in which the feeble signal is eliminated from the input signal by passing it through the band elimination filter 130 inputted thereto, and outputs the differential voltage of these two types of signals. The analog subtracter 131 is corresponding to the analog subtraction unit.

The amplifier 132 amplifies an output voltage of the analog subtracter 131. The voltage comparator 133 compares the output voltage of the amplifier 132 with the predetermined threshold voltage Vref, and renders the output high-level when the output voltage is the threshold voltage Vref or higher.

The above-mentioned feeble signal extracting circuit 100 has basically the same configuration as the pilot signal extracting circuit 22 shown in FIG. 3, and the input-output waveforms of the sections shown in FIG. 4 are applicable as-is.

The two input terminals of the analog subtracter 131 have the signal before eliminating the feeble signal (FIG. 4(A)) and the signal after eliminating the feeble signal (FIG. 4(B)) inputted thereto. Therefore, the analog subtracter 131 can output the differential voltage of these two input signals so as to extract only the feeble signal (FIG. 4(C)) The feeble signal thus extracted is not influenced by the voltage variation due to any other frequency component. Therefore, it is possible, by amplifying a voltage level with the amplifier 132 of the subsequent stage and then having it compared with the predetermined threshold voltage Vref by the voltage comparator 133, to easily generate the pulse signal synchronized with the feeble signal.

Thus, as for the above-mentioned feeble signal extracting circuit 100, it is possible, by using the simple configuration necessary to output the differential voltage of the signal before and after eliminating the feeble signal, to get rid of the influence of the voltage variation other than that of the feeble signal so as to securely extract only the feeble signal.

### Industrial Applicability

As described above, according to the present invention, it is possible, by using a simple configuration for outputting the differential of the signal before and after eliminating the pilot signal, to get rid of the influence of the voltage variation other than that of the pilot signal so as to extract on ly the pilot signal.

1. A feeble signal extracting circuit for separating and extracting a pilot signal superimposed on an FM modulated wave signal, comprising:
a pilot signal elimination unit for eliminating said pilot signal included in said FM modulated wave signal inputted on which said pilot signal is superimposed; and
an analog subtraction unit for outputting a differential of the signal before and after said pilot signal is eliminated by said pilot signal elimination unit.

2. The feeble signal extracting circuit according to claim 1, wherein said pilot signal elimination unit is a band elimination filter for eliminating only a frequency component corresponding to said pilot signal.

3. The feeble signal extracting circuit according to claim 1, further comprising:
an amplifier for amplifying an output signal of said analog subtraction unit; and
a voltage comparator for comparing a voltage of the signal amplified by said amplifier with a predetermined threshold voltage.

4. A feeble signal extracting circuit comprising:
a feeble signal elimination unit for eliminating a feeble signal having a predetermined frequency included in an signal inputted on which said feeble signal is superimposed; and
an analog subtraction unit for outputting a differential of the signal before and after said feeble signal is eliminated by said feeble signal elimination unit.

5. The feeble signal extracting circuit according to claim 4, wherein said feeble signal elimination unit is a band elimination filter for eliminating only a frequency component corresponding to said feeble signal.

6. The feeble signal extracting circuit according to claim 4, wherein said feeble signal is a signal of which crest value is smaller than voltage variation of the signal on which this feeble signal is superimposed.

7. The feeble signal extracting circuit according to claim 4, further comprising:
an amplifier for amplifying an output signal of said analog subtraction unit; and
a voltage comparator for comparing a voltage of the signal amplified by said amplifier with a predetermined threshold voltage.
